(19) United States
(12) Patent Application Publication
(10) Pub. No.: US 2010/0064834 A1
(43) Pub. Date: Mar. 18, 2010

(54) DOUBLE RACK AND PINION OSCILLATING DEVICE

(75) Inventors: Kiyoshi TAKEUCHI, Tsukubamirai-shi (JP); Mitsunori Magaribuchi, Tsukubamirai-shi (JP); Kazuhiro Shinohara, Tsukubamirai-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SMC Corporation, Chiyoda-ku (JP)

(21) Appl. No.: 12/553,376

(22) Filed: Sep. 3, 2009

(30) Foreign Application Priority Data
Sep. 18, 2008 (JP) 2008-239691

(51) Int. Cl. F16H 1/04

(52) U.S. Cl. 74/422

(57) ABSTRACT

A plurality of ring-shaped sealing members are spaced from each other on the outer periphery of each of first and second end caps that seal openings of first and second cylinder holes. Ring-shaped flow paths are formed between adjacent ring-shaped sealing members. Parts of air flow paths that supply and discharge compressed air to and from pressure chambers of the cylinder holes are formed by the ring-shaped flow paths.

### BACKGROUND OF THE INVENTION

1. Field of the Invention

The present invention relates to a double rack and pinion oscillating device, and more specifically, it relates to an oscillating device in which a pair of racks arranged parallel to each other are caused to linearly reciprocate by pistons in opposite directions relative to each other, and an output shaft is thereby caused to rotationally oscillate through a pinion meshed with both the racks.

2. Description of the Related Art

Hitherto, a double rack and pinion oscillating device has been commonly known that includes a pair of pistons having racks arranged parallel to each other, an output shaft having a pinion meshed with both the racks, and supported rotatably around its axis, and in which the pair of pistons are caused to linearly reciprocate in opposite directions relative to each other by fluid pressure, and the output shaft is thereby caused to rotationally oscillate.

In such an oscillating device, when a pair of pistons are caused to linearly reciprocate in opposite directions relative to each other, pressure fluid needs to be alternately supplied to a pressure chamber at one end of one piston and a pressure chamber at the other end of the other piston, and a pressure chamber at the other end of one piston and a pressure chamber at one end of the other piston. However, due to structural and manufacturing limitations, flow paths connecting the pressure chambers can need to be formed so as to straddle the cylinder hole of each piston.

In conventional oscillating devices, as disclosed in the patent documents, Japanese Registered Utility Model No. 2537200 and Japanese Unexamined Patent Application Publication No. 2002-310104, the flow paths are formed by forming flow path grooves in an end plate, or separately preparing a plate in which flow path grooves are formed.

However, in such conventional oscillating devices, it is necessary not only to form complexly-shaped flow path grooves in the surface of a plate but also to prepare complexly-shaped sealing members surrounding the complex flow path grooves, and therefore there is room for improvement in terms of structure and cost.

### BRIEF SUMMARY OF INVENTION

The present invention is intended to solve such a problem. A technical object of the present invention is to make it possible to form flow paths that supply pressure fluid to pressure chambers in a double rack and pinion oscillating device more easily and at low cost.

To solve the above problem, in an aspect of the present invention, a double rack and pinion oscillating device includes a body having a first end and a second end on the side opposite thereto; a first cylinder hole and a second cylinder hole arranged in the body so as to extend from the first end to the second end parallel to each other; a first piston and a second piston that slide in the first and second cylinder holes, respectively; racks provided in the pistons; an output shaft having a pinion meshing with the racks; first pressure chambers formed on the first end side of the first and second cylinder holes by the first and second pistons: second pressure chambers formed on the second end side of the first and second cylinder holes by the first and second pistons; a first air flow path connecting the second pressure chamber of the first cylinder hole and the first pressure chamber of the second cylinder hole; and a second air flow path connecting the first pressure chamber of the first cylinder hole and the second pressure chamber of the second cylinder hole, the first and second pistons being driven synchronously in opposite directions relative to each other by compressed air supplied to the first air flow path and the second air flow path, and the output shaft being thereby rotationally oscillated around its axis. A first opening and a second opening of the first cylinder hole and the second cylinder hole that open at the first end of the body are sealed by a first end cap and a second end cap. On the outer periphery of each of the first end cap and the second end cap, a plurality of ring-shaped sealing members are spaced at intervals in the axial direction of the end cap, and ring-shaped flow paths are formed between adjacent ring-shaped sealing members. Part of the first air flow path is formed by the ring-shaped flow path of the first end cap, and part of the second air flow path is formed by the ring-shaped flow path of the second end cap.

In the double rack and pinion oscillating device according to the present invention, it is preferable that the first air flow path include a first main flow path that connects the second pressure chamber of the first cylinder hole to the first opening, the ring-shaped flow path of the first end cap that communicates with the first main flow path in the first opening, and a first connecting flow path that communicates with the ring-shaped flow path in the first opening and connects the first opening to the first pressure chamber of the second cylinder hole, and the second air flow path include a second main flow path that connects the second pressure chamber of the second cylinder hole to the second opening, the ring-shaped flow path of the second end cap that communicates with the second main flow path in the second opening, and a second connecting flow path that communicates with the ring-shaped flow path in the second opening and connects the second opening to the first pressure chamber of the first cylinder hole.

In a preferred embodiment of the oscillating device according to the present invention, the end caps each have at least three ring-shaped sealing members, and first ring-shaped flow paths communicating with the main flow paths and second ring-shaped flow paths having through holes communicating with the first pressure chambers of the cylinder holes are formed between adjacent ring-shaped sealing members. A first communication hole passing through the body and connecting the first ring-shaped flow path of the first end cap and the second ring-shaped flow path of the second end cap, and a second communication hole passing through the body and connecting the first ring-shaped flow path of the second end cap and the second ring-shaped flow path of the first end cap are provided between the first opening and the second opening. The first connecting flow path is formed by the first communication hole, and the second ring-shaped flow path and the through hole provided in the second end cap, and the second connecting flow path is formed by the second communication hole, and the second ring-shaped flow path and the through hole provided in the first end cap.

In an oscillating device according to an embodiment of the present invention, it is preferable that three ring-shaped grooves in which the ring-shaped sealing members are fitted, and two ring-shaped convex portions located between the ring-shaped grooves be formed on the outer periphery of each of the end caps, ring-shaped spaces be formed between the outer peripheral surfaces of the ring-shaped convex portions and the inner peripheral surface of each of the openings, and the ring-shaped flow paths be formed by these ring-shaped spaces.

The end caps may have recesses communicating with the first pressure chambers of the cylinder holes, and the through holes of the second ring-shaped flow paths may communicate with the recesses. The first ring-shaped flow path of the first end cap and the second ring-shaped flow path of the second end cap may be arranged so as to face each other, the second ring-shaped flow path of the first end cap and the first ring-shaped flow path of the second end cap may be arranged so as to face each other, and the first communication hole and the second communication hole may be arranged parallel to each other.

In another preferred embodiment of the oscillating device according to the present invention, the end caps each have at least two ring-shaped sealing members, and the ring-shaped flow paths are formed between adjacent ring-shaped sealing members. Between the first opening and the first pressure chamber of the second cylinder hole, a first communication hole passing through the body and connecting the ring-shaped flow path of the first end cap and the first pressure chamber is provided. Between the second opening and the first pressure chamber of the first cylinder hole, a second communication hole passing through the body and connecting the ring-shaped flow path of the second end cap and the first pressure chamber is provided. The first connecting flow path and the second connecting flow path are formed by the first communication hole and the second communication hole, respectively.

In an oscillating device according to another embodiment of the present invention, it is preferable that three ring-shaped grooves be formed on the outer periphery of each of the end caps, the ring-shaped sealing members be fitted in the ring-shaped grooves located at both ends in the axial direction of the end caps, and the ring-shaped flow paths be formed by the ring-shaped grooves located in the middle in the axial direction of the end caps.

In the above double rack and pinion oscillating device according to the present invention, i plurality of ring-shaped sealing members are spaced from each other on the outer periphery of each of first and second end caps that seal openings of first and second cylinder holes, ring-shaped flow paths are formed between adjacent ring-shaped sealing members, and parts of air flow paths that supply compressed air to pressure chambers of the cylinder holes are formed by the ring-shaped flow paths. Therefore, air flow paths can be formed relatively easily, and the production cost can be reduced.

### BRIEF DESCRIPTION OF DRAWINGS

FIG. 1 is a perspective view showing the appearance of a double rack and pinion oscillating device according to a first embodiment of the present invention.

FIG. 2 is a schematic transverse sectional view showing the internal structure of a double rack and pinion oscillating device according to a first embodiment of the present invention.

FIG. 3 is an enlarged view of the essential parts of FIG. 2.

FIG. 4 is a sectional view taken along line IV-IV of FIG. 3.

FIG. 5 is a sectional view taken along line V-V of FIG. 3.

FIG. 6 is a sectional view taken along line VI-VI of FIG. 2.

FIG. 7 is a sectional view taken along line VII-VII of FIG. 2.

FIG. 7 is a schematic transverse sectional view showing the internal structure of a double rack and pinion oscillating device according to a second embodiment of the present invention.

FIG. 9 is an enlarged view of the essential parts of FIG. 8.

FIG. 10 is a sectional view taken along line X-X of FIG. 9.

FIG. 11 is a sectional view taken along line XI-XI of FIG. 9.

FIG. 12 is a sectional view taken along line XII-XII of FIG. 8.

FIG. 13 is a sectional view taken along line XIII-XIII of FIG. 8.

### DETAILED DESCRIPTION OF INVENTION

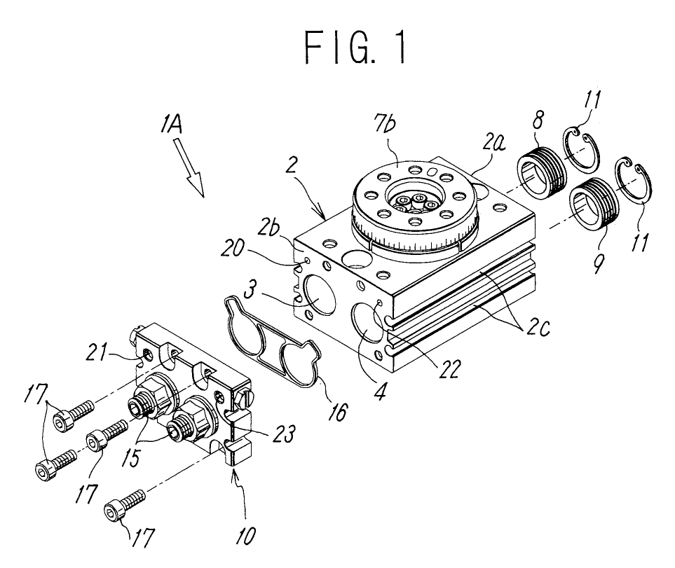

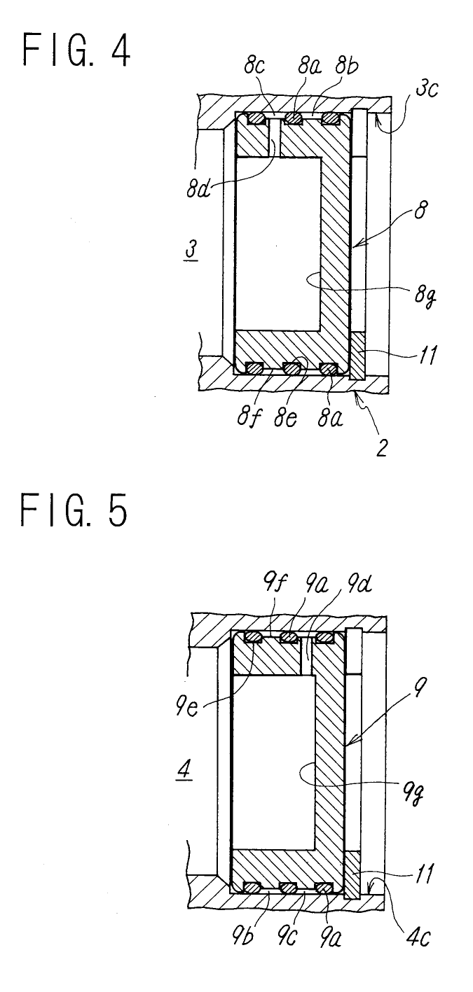

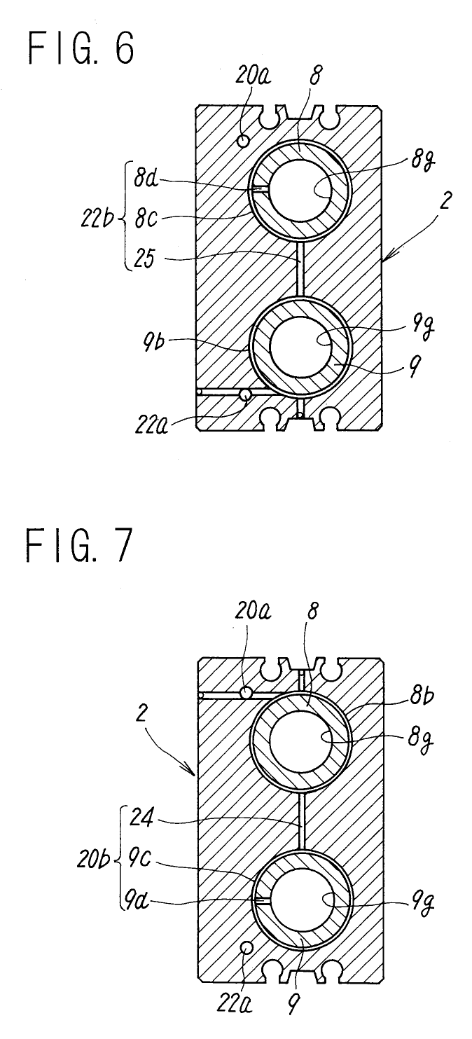

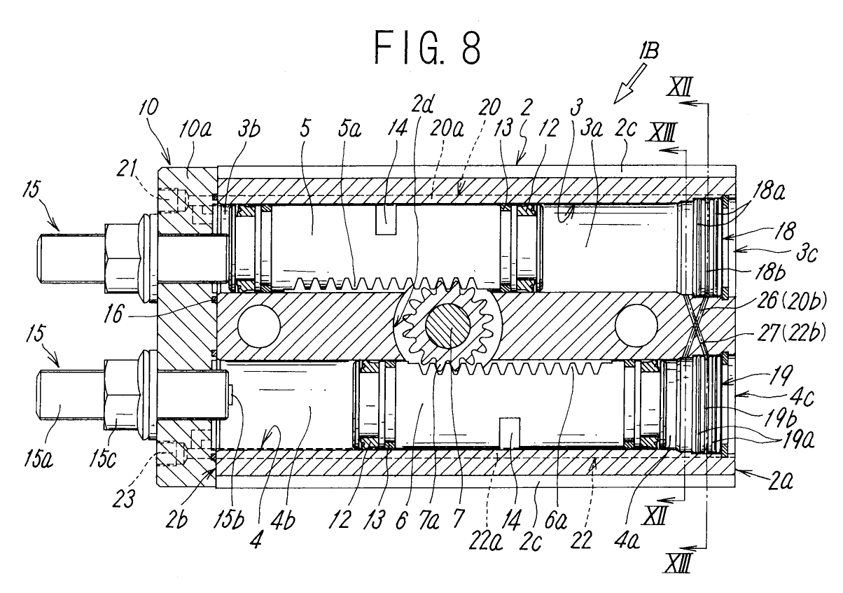

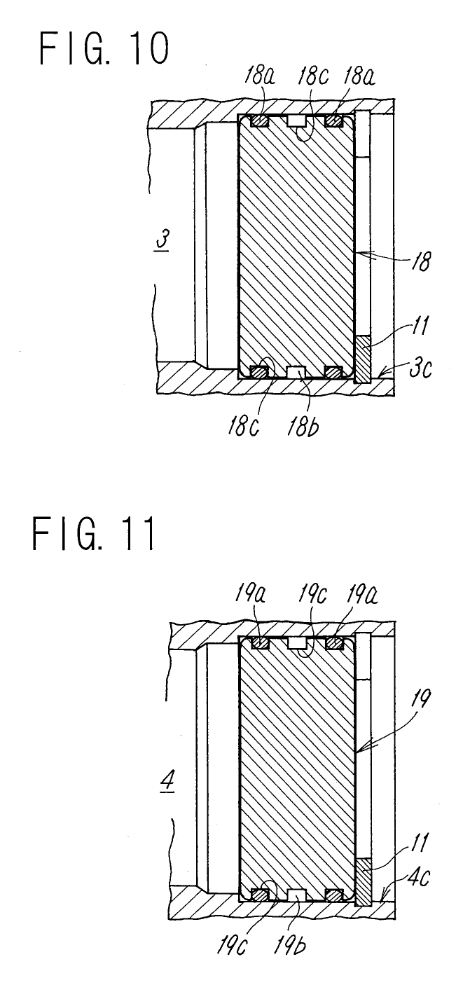

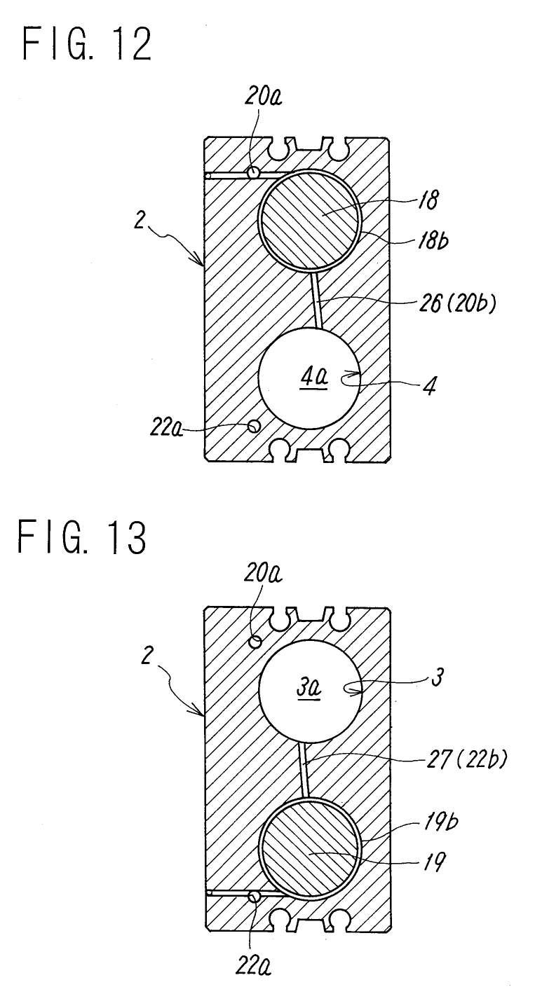

Embodiments of a double rack and pinion oscillating device according to the present invention will now be described with reference to FIGS. 1 to 13.

FIGS. 1 to 4(b) show a double rack and pinion oscillating device 1A according to a first embodiment of the present invention.

This double rack and pinion oscillating device 1A generally includes a body 2 that has a first end 2a and a second end 2b at both ends in the longitudinal direction (axial direction), a first cylinder hole 3 and a second cylinder hole 4 that extend in the body 2 from the first end 2a to the second end 2b parallel to each other, a first piston 5 and a second piston 6 that are slidably placed in the first and second cylinder holes 3 and 4, respectively, and have toothed racks 5a and 6a at positions facing each other in their sides, an output shaft 7 that is supported at a position between the pistons 5 and 6 in the body 2 rotatably around an axis perpendicular to the axes of the pistons 5 and 6 and to which a pinion 7a meshing with the racks 5a and 6a is attached, a first end cap 8 and a second end cap 9 that seal openings of the first and second cylinder holes 3 and 4 on the first end 2a side, and an end plate 10 that seals openings of the cylinder holes 3 and 4 on the second end 2b side. The first and second pistons 5 and 6 ale caused to linearly reciprocate synchronously in opposite directions relative to each other by compressed air, and the output shaft 7 is thereby rotationally oscillated.

The body 2 is integrally formed substantially in a rectangular solid shape by extruding a metal material such as aluminum. Between the first end 2a and the second end 2b thereof, the first and second cylinder holes 3 and 4 are provided. The insides of the first cylinder holes 3 and 4 are divided into first pressure chambers 3a and 4a on the first end 2a side of the body 2 and second pressure chambers 3b and 4b on the second end 2b side of the body 2. In openings of the first and second cylinder holes 3 and 4 on the first end 2a side, a first opening 3c and a second opening 4c are formed that are larger in diameter than parts where the first and second pistons 5 and 6 slide. In these openings 3c and 4c, the end caps 8 and 9 are fitted in an airtight manner. These end caps 8 and 9 are held so as not to come off, by C-shaped rings 11, 11 that are engaged with and fixed to the inner walls of the openings 3c and 4c. In both side surfaces of the body 2, sensor attaching grooves 2c for attaching sensors (not shown) that detect the positions of the pistons 5 and 6 are formed parallel to the cylinder holes 3 and 4.

The first and second pistons 5 and 6 are each integrally molded in a solid substantially cylindrical shape. At each end in the axial direction of each piston, a lip-shaped ring-shaped sealing member 12 formed of an elastic body and a ring-shaped wear ring 13 formed of resin are adjacently provided, and the first pressure chambers 3a and 4a and the second pressure chambers 3b and 4b are thereby kept airtight. In the middle parts between the ring-shaped wear rings 13, 13 in the pistons 5 and 6, the pair of racks 5a and 6a are provided so as to face each other, and magnets 14 are attached. By detecting these magnets 14 with sensors attached to the sensor attaching grooves 2c, the positions of the pistons 5 and 6 are detected.

The output shaft 7 is rotatably supported by a bearing (not shown) in a shaft hole 2d that extending through the middle of the body 2 in a direction perpendicular to the axes of the cylinder holes 3 and 4. The output shaft 7 has the pinion 7a at one end thereof and has a table 7b coaxially fixed to the other end thereof. The table 7b is placed on the top of the body 2 and is configured to rotationally oscillate together with the output shaft 7.

The end plate 10 includes a plate main body 10a integrally molded substantially in the same shape and size as the end face of the second end 2b of the body 2, and two adjusters 15, 15 for adjusting the reciprocating range of the pistons 5 and 6 and thereby adjusting the angle of rotational oscillation of the output shaft 7. At positions near the first and second cylinder holes 3 and 4 in the plate main body 10a, first and second ports 21 and 23 are provided that are connected to a pressure source through a solenoid valve (not shown), for example, and supply and discharge compressed air to and from the first and second pressure chambers 3a, 3b, 4a, and 4b of the cylinder holes 3 and 4. The end plate 10 is fixed to the end face of the second end 2b of the body 2 with a sealing member 16 therebetween by a plurality of fixing bolts 17 serving as fixing means. The end plate 10 hermetically seals the openings of the cylinder holes 3 and 4 on the second end 2b side of the body 2.

The adjusters 15 each includes an adjusting bolt 15a, a cushion pad 15b, and an adjusting nut 15c. The adjusting bolt 15a has a male thread on the outer peripheral surface, is screwed into a screw hole of the end plate 10, and thereby passes through the end plate 10 in an airtight manner. The front ends of the adjusting bolts 15a are placed in the second pressure chambers 3b and 4b of the cylinder holes 3 and 4. The cushion pad 15b is provided on the front end face of the adjusting bolt 15a and is formed of an elastic body. The adjusting nut 15c is attached to the adjusting bolt 15a on the outer side of the end plate 10.

By screwing the adjusting bolts 15a in the axial direction and adjusting the amount of projection of the adjusting bolts 15a into the second pressure chambers 3b and 4b, the reciprocating ranges of the pistons 5 and 6 can be adjusted. By the cushion pads 15b, the shock of the impact of the end faces of the pistons 5 and 6 against the adjusters 15 can be absorbed.

The oscillating device 1A further includes a first air flow path 20 that connects the second pressure chamber 3b of the first cylinder hole 3 and the first pressure chamber 4a of the second cylinder hole 4, and a second air flow path 22 that connects the first pressure chamber 3a of the first cylinder hole 3 and the second pressure chamber 4b of the second cylinder hole 4. The first and second ports 21 and 23 are connected to the first and second air flow paths 20 and 22, respectively. By supplying and discharging compressed air through these ports 21 and 23, the first and second pistons 5 and 6 are caused to reciprocate synchronously in opposite directions relative to each other in the first and second cylinder holes 3 and 4, respectively, and the output shaft 7 and the table 7b are caused to rotationally oscillated.

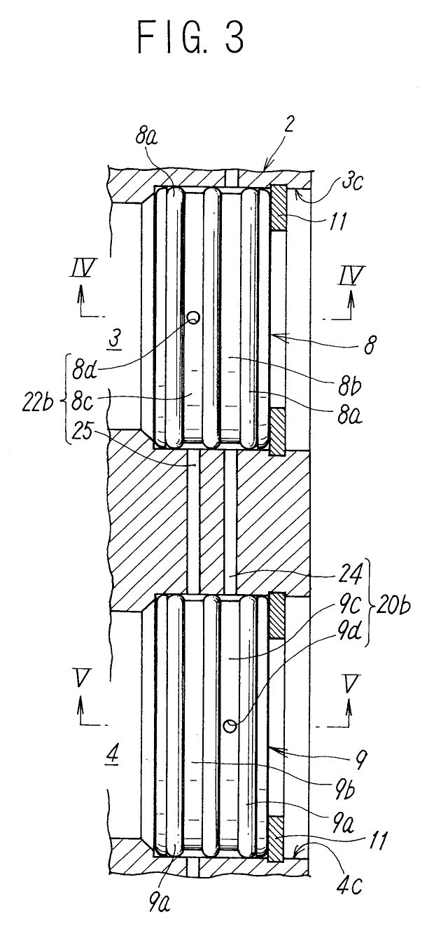

In the first embodiment, the end caps 8 and 9 each have three ring-shaped sealing members 8a, 9a as shown in FIGS. 3 to 5. The ring-shaped sealing members 8a, 9a are placed on the outer periphery around the axis of each of the end caps 8 and 9, are spaced at intervals in the axial direction, and are formed of an elastic body. Between these adjacent ring-shaped sealing members 8a, 9a, a first ring-shaped flow path 8b, 9b and a second ring-shaped flow path 8c, 9c are formed. The first end cap 8 is provided with a through hole 8d that connects the second ring-shaped flow path 8c of the first end cap 8 and the first pressure chamber 3a of the first cylinder hole 3. The second end cap 9 is provided with a through hole 9d that connects the second ring-shaped flow path 9c of the second end cap 9 and the first pressure chamber 4a of the second cylinder hole 4.

More specifically, three ring-shaped grooves 8e, 9e and two ring-shaped convex portions 8f, 9f are formed on the outer periphery of each of the end caps 8 and 9. The ring-shaped sealing members 8a, 9a are fitted in the ring-shaped grooves 8e, 9e. The ring-shaped convex portions 8f, 9f are located between adjacent ring-shaped grooves 8e, 9e and have a diameter smaller than the maximum diameter of the end caps 8 and 9. When the end caps 8 and 9 are fitted in the openings 3c and 4c, respectively, ring-shaped spaces are formed between the outer peripheral surfaces of the ring-shaped convex portions 8f, 9f and the inner peripheral surface of each of the openings 3c and 4c. By these ring-shaped spaces, the first ring-shaped flow paths 8b and 9b and the second ring-shaped flow paths 8c and 9c are formed.

The first ring-shaped flow path 8b and the second ring-shaped flow path 8c of the first end cap 8 and the first ring-shaped flow path 9b and the second ring-shaped flow path 9c of the second end cap 9 are arranged alternately. So, the first ring-shaped flow path 8b of the first end cap 8 and the second ring-shaped flow path 9c of the second end cap 9 are arranged opposite each other, and the second ring-shaped flow path 8c of the first end cap 8 and the first ring-shaped flow path 9b of the second end cap 9 are arranged opposite each other.

The end caps 8 and 9 further have recesses 8g and 9g, respectively, the openings of which face the first pressure chambers 3a and 4a of the cylinder holes 3 and 4. The through holes 8d and 9d extend in the radial direction between the outer peripheral surfaces of the ring-shaped convex portions 8f and 9f, respectively, that form the second ring-shaped flow paths 8c and 9c, respectively, and the recesses 8g and 9g, respectively.

In the first embodiment, the first and second end caps 8 and 9 are formed in the same shape and size except for the positions of the through holes 8d and 9d.

As described below in detail, the oscillating device 1A uses the first and second end caps 8 and 9 having the above-described structure, instead of a conventional plate having complexly-shaped flow path grooves formed in the surface, and parts of the first and second air flow paths 20 and 22 are formed by the ring-shaped flow paths 8b, 8c, 9b, and 9c.

That is, the first air flow path 20 includes a first main flow path 20a that connects the second pressure chamber 3b of the first cylinder hole 3 and the first opening 3c of the first cylinder hole 3, the first ring-shaped flow path 8b of the first end cap 8 that is connected to the first main flow path 20a in the first opening 3c, and a first connecting flow path 20b that is connected to the first ring-shaped flow path 8b in the first opening 3c and connects the first opening 3c and the first pressure chamber 4a of the second cylinder hole 4.

The first main flow path 20a extends along the first cylinder hole 3 in the body 2 and in the plate main body 10a of the end plate 10 and is connected to the first port 21 in the plate main body 10a.

The first connecting flow path 20b is formed by a first communication hole 24, and the second ring-shaped flow path 9c and the through hole 9d in the second end cap 9. The first communication hole 24 passes through the inside of the body 2 and connects the first ring-shaped flow path 8b of the first end cap 8 and the second ring-shaped flow path 9c of the second end cap 9 between the first and second openings 3c and 4c.

The second air flow path 22 includes a second main flow path 22a that connects the second pressure chamber 4b of the second cylinder hole 4 and the second opening 4c of the second cylinder hole 4, the first ring-shaped flow path 9b of the second end cap 9 that is connected to the second main flow path 22a in the second opening 4c, and a second connecting flow path 22b that is connected to the first ring-shaped flow path 9b in the second opening 4c and connects the second opening 4c and the first pressure chamber 3a of the first cylinder hole 3.

The second main flow path 22a extends along the second cylinder hole 4 in the body 2 and in the plate main body 10a of the end plate 10 and is connected to the second port 23 in the plate main body 10a.

The second connecting flow path 22b is formed by a second communication hole 25, and the second ring-shaped flow path 8c and the through hole 8d in the first end cap 8. The second communication hole 25 passes through the inside of the body 2 and connects the first ring-shaped flow path 9b of the second end cap 9 and the second ring-shaped flow path 8c of the first end cap 8 between the first and second openings 3c and 4c.

As described above, in the oscillating device 1A according to the first embodiment, the first ring-shaped flow path 8b and the second ring-shaped flow path 8c of the first end cap 8 and the first ring-shaped flow path 9b and the second ring-shaped flow path 9c of the second end cap 9 are arranged alternately, and therefore the first communication hole 24 and the second communication hole 25 are arranged parallel to each other. However, the positional relationship between the first and second ring-shaped flow paths 8b and 8c of the first end cap 8 and the first and second ring-shaped flow path 9b and 9c of the second end cap 9 is not limited to the shown one.

Next, the operation of the oscillating device 1A having the above-described structure will be described.

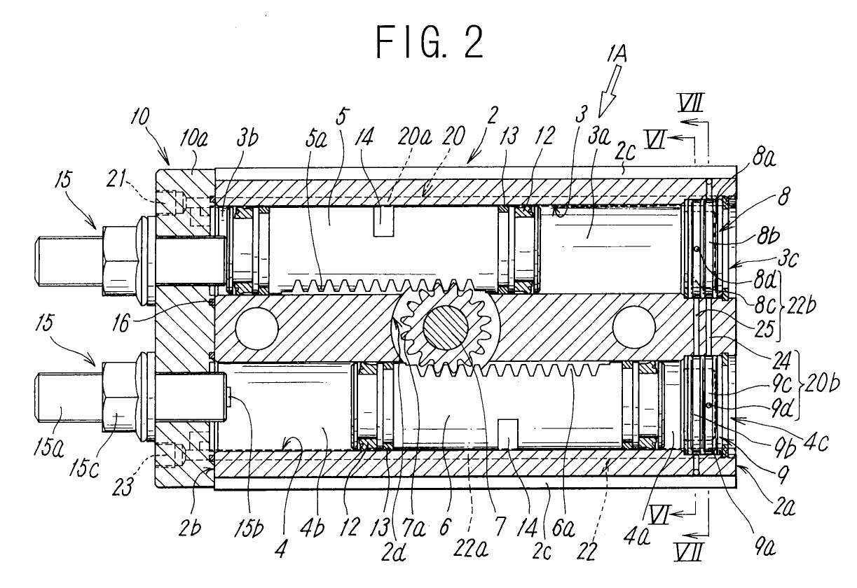

First, in the state of FIG. 2, compressed air is supplied through the first port 21. The compressed air is supplied through the first main flow path 20a. to the second pressure chamber 3b of the first cylinder hole 3. At the same time, the compressed air is supplied through the first main flow path 20a, the first ring-shaped flow path 8b of the first end cap 8, the first connecting flow path 20b (that is, the first communication hole 24, and the second ring-shaped flow path 9c and the through hole 9d in the second end cap 9), and the recess 9g of the second end cap 9 to the first pressure chamber 4a of the second cylinder hole 4.

The first piston 5 is driven in the first cylinder hole 3 toward the first end 2a of the body 2, and the second piston 6 is driven in the second cylinder hole 4 toward the second end 2b of the body 2 until the second piston 6 comes into contact with the adjuster 15. At the same time, the output shaft 7 rotates to the right around its axis by a predetermined angle. At that time, the air in the first pressure chamber 3a of the first cylinder hole 3 and the second pressure chamber 4b of the second cylinder hole 4 is discharged through the second air flow path 22 and the second port 23 to the atmosphere.

Next, in this state, compressed air is supplied through the second port 23. The compressed air is supplied through the second main flow path 22a to the second pressure chamber 4b of the second cylinder hole 4. At the same time, the compressed air is supplied through the second main flow path 22a, the first ring-shaped flow path 9b of the second end cap 9, the second connecting flow path (that is, the second communication hole 25, and the second ring-shaped flow path 8c and the through hole 8d in the first end cap 8), and the recess 8g of the first end cap 8 to the first pressure chamber 3a of the first cylinder hole 3.

The first piston 5 is driven in the first cylinder hole 3 toward the second end 2b of the body 2 until the first piston 5 comes into contact with the adjuster 15 (the state of FIG. 2), and the second piston 6 is driven in the second cylinder hole 4 toward the first end 2a of the body 2. At the same time, the output shaft 7 rotates to the left around its axis by a predetermined angle. At that time, the air in the second pressure chamber 3b of the first cylinder hole 3 and the first pressure chamber 4a of the second cylinder hole 4 is discharged through the first air flow path 20 and the first port 21 to the atmosphere.

By repeating the above-described operations, the output shaft 7 can be rotationally oscillated.

As described above, in the oscillating device 1A according to the first embodiment, a plurality of ring-shaped sealing members 8a, 9a are spaced from each other on the outer periphery of each of first and second end caps 8 and 9 that seal the openings of the first and second cylinder holes 3 and 4, ring-shaped flow paths 8b, 8c, 9b, 9c are formed between adjacent ring-shaped sealing members 8a, 9a, and parts of air flow paths 20 and 22 that supply and discharge compressed air to and from pressure chambers 3a, 3b, 4a, and 4b of the first and second cylinder holes 3 and 4 are formed by the ring-shaped flow paths. Therefore, ail flow paths 20 and 22 can be relatively easily formed. As a result, the production cost can be reduced.

In the first embodiment, the end caps 8 and 9 each have three ring-shaped sealing members 8a, 9a. However, the number of the ring-shaped sealing members may be four or more. That is, the end caps 8 and 9 each have at least three ring-shaped sealing members 8a, 9a, and the first and second ring-shaped flow paths are formed between adjacent ring-shaped sealing members.

FIGS. 8 to 13 show a double rack and pinion oscillating device 1B according to a second embodiment of the present invention.

A description will be given mainly of differences from the first embodiment. The same reference numerals will be used to designate the same components as those in the first embodiment, and redundant description will be omitted.

The oscillating device 1B according to the second embodiment differs from the oscillating device 1A according to the first embodiment mainly in the structure of the first and second end caps and the structure of the first and second connecting flow paths.

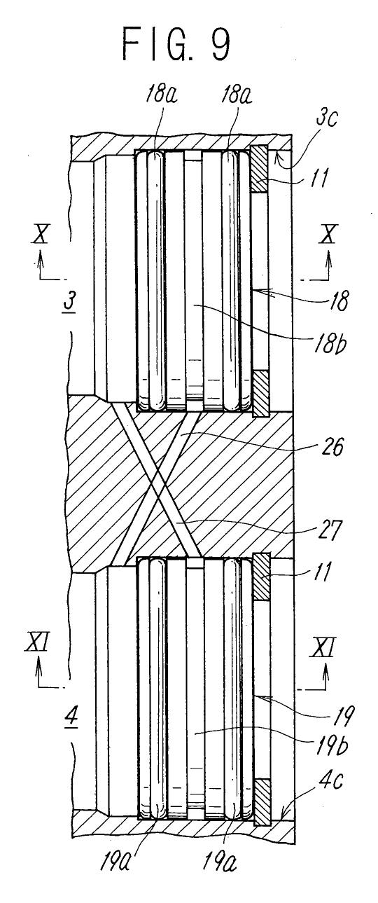

The first and second end caps 18 and 19 in the second embodiment are formed in the same shape and size as shown in FIGS. 9 to 11 and each have two ring-shaped sealing members 18a, 19a. The ring-shaped sealing members 18a, 19a are placed on the outer periphery around the axis of each of the end caps 18 and 19, are spaced at intervals in the axial direction, and are formed of an elastic body. Between these ring-shaped sealing members 18a, 19a, ring-shaped flow paths 18b 19b are formed.

More specifically, thee ring-shaped grooves 18c, 19c are formed on the outer periphery of each of the end caps 18 and 19 substantially at regular intervals in the axial direction. The ring-shaped sealing members 18a, 19a are fitted in the ring-shaped grooves 18c, 19c located at both ends in the axial direction. The ring-shaped flow paths 18b and 19b are formed by the ring-shaped grooves 18c, 19c located in the middle in the axial direction. That is, when the end caps 18 and 19 are fitted in the first and second openings 3c and 4c of the cylinder holes 3 and 4, the ring-shaped flow paths 18b and 19b are formed by ring-shaped spaces surrounded by the ring-shaped grooves 18c, 19c located in the middle in the axial direction and the inner peripheral surface of each of the openings 3c and 4c.

As described below in detail, the oscillating device 1B uses the first and second end caps 18 and 19 having the above-described structure, and parts of the first and second air flow paths 20 and 22 are formed by the ring-shaped flow paths 18b and 19b, respectively.

That is, the first air flow path 20 includes a first main flow path 20a that connects the second pressure chamber 3b of the first cylinder hole 3 and the first opening 3c of the first cylinder hole 3, the ring-shaped flow path 18b of the first end cap 18 that is connected to the first main flow path 20a in the first opening 3c, and a first connecting flow path 20b that is connected to the ring-shaped flow path 18b in the first opening 3c and connects the first opening 3c and the first pressure chamber 4a of the second cylinder hole 4.

The first connecting flow path 20b is formed by a first communication hole 26 that passes through the inside of the body 2 and directly connects the ring-shaped flow path 18b of the first end cap 18 and the first pressure chamber 4a of the second cylinder hole 4, between the first opening 3c and 4c and the first pressure chamber 4a of the second cylinder hole 4.

The second air flow path 22 includes a second main flow path 22a that connects the second pressure chamber 4b of the second cylinder hole 4 and the second opening 4c of the second cylinder hole 4, the ring-shaped flow path 19b of the second end cap 19 that is connected to the second main flow path 22a in the second opening 4c, and a second connecting flow path 22b that is connected to the ring-shaped flow path 19b in the second opening 4c and connects the second opening 4c and the first pressure chamber 3a of the first cylinder hole 3.

The second connecting flow path 22b is formed by a second communication hole 27 that passes through the inside of the body 2 and directly connects the ring-shaped flow path 19b of the second end cap 19 and the first pressure chamber 3a of the first cylinder hole 3, between the second opening 4c and the first pressure chamber 3a of the first cylinder hole 3.

The connecting flow paths 20b and 22b, that is, the communication holes 26 and 27 open at positions near the end caps 19 and 18 in the first pressure chambers 4a and 3a. The diameter of the cylinder holes 3 and 4 at the opening positions is larger than the diameter of parts where the pistons 5 and 6 slide, and is smaller than the diameter of the openings 3c and 4c. The first and second communication holes 26 and 27 are in a torsion positional relationship so as not to intersect with each other in the body 2.

The operation of the oscillating device 1B according to the second embodiment is basically the same as the first embodiment, and so the description thereof will be omitted.

As described above, also in the oscillating device 1B according to the second embodiment, as in the case of the first embodiment, a ring-shaped flow path 18b, 19b is formed on the outer periphery around the axis of each of end caps 18 and 19, the ring-shaped flow paths 18b and 19b form parts of the air flow paths 20 and 22, and air flow paths 20 and 22 can thereby be relatively easily formed. As a result, the production cost can be reduced. In addition, since the first and second end caps 18 and 19 are identical components and the air flow paths 20 and 22 can have simpler structure, the cost can be further reduced.

In the second embodiment, the end caps 18 and 19 each have two ring-shaped sealing members 18a, 19a. However, the number of the ring-shaped sealing members may be three or more. That is, the end caps 18 and 19 each have at least two ring-shaped sealing members 18a, 19a, and the ring-shaped flow paths are formed between adjacent ring-shaped sealing members.

1. A double rack and pinion oscillating device comprising: a body having a first end and a second end on the side opposite thereto; a first cylinder hole and a second cylinder hole arranged in the body so as to extend from the first end to the second end parallel to each other; a first piston and a second piston that slide in the first and second cylinder holes, respectively; racks provided in the pistons; an output shaft having a pinion meshing with the racks; first pressure chambers formed on the first end side of the first and second cylinder holes by the first and second pistons; second pressure chambers formed on the second end side of the first and second cylinder holes by the first and second pistons; a first air flow path connecting the second pressure chamber of the first cylinder hole and the first pressure chamber of the second cylinder hole; and a second air flow path connecting the first pressure chamber of the first cylinder hole and the second pressure chamber of the second cylinder hole, the first and second pistons being driven synchronously in opposite directions relative to each other by compressed air supplied to the first air flow path and the second air flow path, and the output shaft being thereby rotationally oscillated around its axis,
wherein a first opening and a second opening of the first cylinder hole and the second cylinder hole that open at the first end of the body are sealed by a first end cap and a second end cap,
wherein on the outer periphery of each of the first end cap and the second end cap, a plurality of ring-shaped sealing members are spaced at intervals in the axial direction of the end cap, and ring-shaped flow paths are formed between adjacent ring-shaped sealing members, and
wherein part of the first air flow path is formed by the ring-shaped flow path of the first end cap, and part of the second air flow path is formed by the ring-shaped flow path of the second end cap.

2. The double rack and pinion oscillating device according to claim 1, wherein the first air flow path includes a first main flow path that connects the second pressure chamber of the first cylinder hole to the first opening, the ring-shaped flow path of the first end cap that communicates with the first main flow path in the first opening, and a first connecting flow path that communicates with the ring-shaped flow path in the first opening and connects the first opening to the first pressure chamber of the second cylinder hole, and
wherein the second air flow path includes a second main flow path that connects the second pressure chamber of the second cylinder hole to the second opening, the ring-shaped flow path of the second end cap that communicates with the second main flow path in the second opening, and a second connecting flow path that communicates with the ring-shaped flow path in the second opening and connects the second opening to the first pressure chamber of the first cylinder hole.

3. The double rack and pinion oscillating device according to claim 2, wherein the end caps each have at least three ring-shaped sealing members, and first ring-shaped flow paths communicating with the main flow paths and second ring-shaped flow paths having through holes communicating with the first pressure chambers of the cylinder holes are formed between adjacent ring-shaped sealing members,
wherein a first communication hole passing through the body and connecting the first ring-shaped flow path of the first end cap and the second ring-shaped flow path of the second end cap, and a second communication hole passing through the body and connecting the first ring-shaped flow path of the second end cap and the second ring-shaped flow path of the first end cap are provided between the first opening and the second opening, and
wherein the first connecting flow path is formed by the first communication hole, and the second ring-shaped flow path and the through hole provided in the second end cap, and the second connecting flow path is formed by the second communication hole, and the second ring-shaped flow path and the through hole provided in the first end cap.

4. The double rack and pinion oscillating device according to claim 3, wherein three ring-shaped grooves in which the ring-shaped sealing members are fitted, and two ring-shaped convex portions located between the ring-shaped grooves are respectively formed on the outer periphery of each of the end caps, ring-shaped spaces are respectively formed between the outer peripheral surfaces of the ring-shaped convex portions and the inner peripheral surface of each of the openings, and the ring-shaped flow paths are formed by these ring-shaped spaces, respectively.

5. The double rack and pinion oscillating device according to claim 3, wherein the end caps have recesses communicating with the first pressure chambers of the cylinder holes, and the through holes of the second ring-shaped flow paths communicate with the recesses.

6. The double rack and pinion oscillating device according to claim 4, wherein the end caps have recesses communicating with the first pressure chambers of the cylinder holes, and the through holes of the second ring-shaped flow paths communicate with the recesses.

7. The double rack and pinion oscillating device according to claim 3, wherein the first ring-shaped flow path of the first end cap and the second ring-shaped flow path of the second end cap are arranged so as to face each other, the second ring-shaped flow path of the first end cap and the first ring-shaped flow path of the second end cap are arranged so as to face each other, and the first communication hole and the second communication hole are arranged parallel to each other.

8. The double rack and pinion oscillating device according to claim 4, wherein the first ring-shaped flow path of the first end cap and the second ring-shaped flow path of the second end cap are arranged so as to face each other, the second ring-shaped flow path of the first end cap and the first ring-shaped flow path of the second end cap are arranged so as to face each other, and the first communication hole and the second communication hole are arranged parallel to each other.

9. The double rack and pinion oscillating device according to claim 5, wherein the first ring-shaped flow path of the first end cap and the second ring-shaped flow path of the second end cap are arranged so as to face each other, the second ring-shaped flow path of the first end cap and the first ring-shaped flow path of the second end cap are arranged so as to face each other, and the first communication hole and the second communication hole are arranged parallel to each other.

10. The double rack and pinion oscillating device according to claim 6, wherein the first ring-shaped flow path of the first end cap and the second ring-shaped flow path of the second end cap are arranged so as to face each other, the second ring-shaped flow path of the first end cap and the first ring-shaped flow path of the second end cap are arranged so as to face each other, and the first communication hole and the second communication hole are arranged parallel to each other.

11. The double rack and pinion oscillating device according to claim 2, wherein the end caps each have at least two ring-shaped sealing members, and the ring-shaped flow paths are formed between adjacent ring-shaped sealing members,
wherein between the first opening and the first pressure chamber of the second cylinder hole, a first communication hole passing through the body and connecting the ring-shaped flow path of the first end cap and the first pressure chamber is provided, and between the second opening and the first pressure chamber of the first cylinder hole, a second communication hole passing through the body and connecting the ring-shaped flow path of the second end cap and the first pressure chamber is provided, and
wherein the first connecting flow path and the second connecting flow path are formed by the first communication hole and the second communication hole, respectively.

12. The double rack and pinion oscillating device according to claim 11, wherein three ring-shaped grooves are formed on the outer periphery of each of the end caps, the ring-shaped sealing members are put in the ring-shaped grooves located it both ends in the axial direction of the end caps, and the ring-shaped flow paths are formed by the ring-shaped grooves located in the middle in the axial direction of the end caps.
